(19) United States
(12) Patent Application Publication
(10) Pub. No.: US 2015/0111300 A1
(43) Pub. Date: Apr. 23, 2015

(54) APPARATUS FOR PRETREATING BIOLOGICAL SAMPLES, AND MASS SPECTROMETER EQUIPPED WITH SAME

(71) Applicant: HITACHI HIGH-TECHNOLOGIES CORPORATION, Tokyo (JP)

(72) Inventors: Makoto NOGAMI, Tsuchiura (JP); Katsuhiro KANDA, Hitachinaka (JP); Izumi WAKI, Tokyo (JP)

(21) Appl. No.: 14/578,619

(22) Filed: Dec. 22, 2014

Related U.S. Application Data
(62) Division of application No. 13/146,656, filed on Sep. 9, 2011.

(30) Foreign Application Priority Data
Jan. 29, 2009 (JP) 2009-017453

(51) Int. Cl. G01N 1/40; G01N 35/00; G01N 35/02

(52) U.S. Cl. CPC G01N 1/405; G01N 35/025; G01N 35/00663
USPC 436/50

(57) ABSTRACT

A clinical laboratory apparatus includes a pretreating apparatus having a high separation capability and providing high data reproducibility and reliability and a mass spectrometer is provided which executes fully automatic processing from pretreatment to detection. The pretreating apparatus that includes a cartridge for holding an extraction agent for solid-phase extraction, a pressure-loading unit for applying a pressure load to any cartridge mounted on the solid-phase extraction cartridge-retaining unit, a receiving tray mechanism for receiving a sample extracted from the cartridge, and a liquid-level sensor for detecting liquid levels in the receiving tray as well as in the cartridge, conducts feedback control for the pressure-loading unit to open its pressure release valve upon the liquid-level sensor detecting that the liquid level in the receiving tray mechanism has reached a preset liquid-level position.

This is a divisional application of U.S. Ser. No. 13/146,656, filed Sep. 9, 2011, which is a 371 National Stage Application of PCT/JP2010/000119, filed Jan. 13, 2010 which claims priority to JP 2009-017453, filed Jan. 29, 2009, the entire disclosures of all applications listed above are hereby incorporated by reference.

### TECHNICAL FIELD

This invention relates to a testing/analyzing apparatus that automatically analyzes constituents contained in samples derived from a biological sample such as blood, serum, plasma, cell tissue, or urine.

### BACKGROUND ART

Methods for conducting qualitative/quantitative analyses on blood, urine, and other biological samples, are represented by two techniques. One is colorimetric analysis, which uses a photometer to analyze a change in a color of a reagent formed so as to change its color upon reacting with the analysis object in the sample. The other is immunoassay methods, which use appending biochemical labels directly or indirectly to a substance that specifically binds to a constituent to be analyzed, and then counting the labels in the analysis object. The analysis of biological samples that applies physical-chemical approaches using a mass spectrometer has been attempted in recent years, the analytical method of which is estimated to expand the range of its application in the future.

In the case where the constituents contained in a sample derived from a biological sample such as blood, serum, plasma, cell tissue, or urine, are tested/analyzed by mass spectrometry, large quantities of constituents ranging over at least several tens of thousands of kinds are present in mixed form in such a biological sample. Thus these constituents become difficult to detect accurately, if the very large number of kinds of constituents are simultaneously introduced into the mass spectrometer. Accordingly, it is essential to fully concentrate and purify the biological sample during its pretreatment. A solid-phase extraction method is generally used to treat a large number of samples as a pretreatment step in mass spectrometry.

Techniques for conducting solid-phase extraction automatically for enhanced pretreatment efficiency are proposed. Patent Documents 1 and 2, for example, disclose extraction methods that use a 96-well solid-phase extraction plate having 96 wells (12 vertically by 8 horizontally) on the plate. These conventional extraction methods each enable a maximum of 96 samples to be extracted at the same time by extracting samples while applying a negative pressure or a positive pressure equally to all wells.

Techniques for preventing the occurrence of a mist due to the application of a pressure during solid-phase extraction are also proposed. Patent Document 3, for example, discloses a nucleic-acid extraction apparatus having a mechanism that opens a pressure release valve upon completion of sample discharging from an extraction cartridge in order to prevent residual pressurizing air from blowing out from a discharge port of the extraction cartridge together with the liquid. The extraction apparatus in Patent Document 3, by preventing residual pressurizing air from blowing out, prevents a mist of liquid effluent from splashing that will result in contamination of surroundings.

In addition, Patent Document 4 discloses an automatic analyzer that includes a liquid-level detection mechanism using a CCD camera.

### PRIOR ART LITERATURE

### Patent Documents

Patent Document 1: JP-2006-7081-A
Patent Document 2: EP1 159 597 B1
Patent Document 3: JP-2005-204578-A
Patent Document 4: JP-2007-298445-A

### SUMMARY OF THE INVENTION

### Problems to be Solved by the Invention

During mass-spectrometric testing/analyzing of the constituents contained in such a biologically derived sample as blood, serum, plasma, cell tissue, or urine, it is important to acquire highly reliable as well as highly reproducible data, and to respond flexibly to diverse, irregular needs of the clinical laboratory site by automation. Improving data reproducibility and reliability requires sufficiently concentrating/purifying the sample in a pretreating step. To this end, it is imperative to appropriately manage the purifying step by extracting the sample while detecting, with a liquid-level sensor, liquid levels in a solid-phase extraction cartridge and in a receiving tray which is to receive the constituents extracted.

Such automated solid-phase extraction as disclosed in Patent Documents 1, 2 has posed a problem in that even when an equal pressure is applied to all wells, particular viscosity of the sample, presence of impurities, or other states of the sample may cause an extraction rate to vary from well to well and thus a residue of the liquid sample to remain on the solid-phase extraction element. In order to solve this problem, a method in which the total amount of sample added to one solid-phase extraction cartridge is passed therethrough by applying a sufficiently high pressure or applying a pressure over time has been used. In this conventional method, solid-phase extraction seemingly takes place equally in all wells. In actuality, however, the speed at which the sample or an eluate passes through a cartridge may vary due to the viscosity of the sample or a particular state (degree of clogging) of a filter, which is fixed either above or below a solid-phase extraction agent, as a result of the passage of the sample through the cartridge. These factors result in variations in contact efficiency (i.e., linear velocity) with respect to a solid-phase extraction agent. These variations in the conventional method have led to failure to obtain high reproducibility during purification. There has additionally been a problem in that if a sufficiently high pressure is applied to the solid-phase extraction cartridge, after the elution of the sample by the application of the pressure, the residual pressurizing air blown out from a discharge port of the extraction cartridge together with the liquid will cause a mist of liquid effluent to splash, and resultantly contaminate surroundings.

While the method disclosed in Patent Document 3 is intended to prevent the occurrence of a mist, it is difficult, during detection of changes in an internal pressure of an extraction column immediately after discharging of the entire solution, to completely prevent the splashing of the mist or droplet form of liquid effluent that occurs immediately before the total amount of solution is discharged. In addition, the sample cannot be extracted during its separation/fractionation in the extraction step.

The automatic analyzer in Patent Document 4 includes a CCD camera to detect liquid levels in such a form as to enable laboratory testing while detecting that reaction reagents are being appropriately added or diluted. However, the apparatus does not accommodate such time-varying changes in liquid level as observed during the solid-phase extraction that moves the solution from an upper section of a solid-phase cartridge to a lower section thereof. Nor does the apparatus have a mechanism that feeds back a variation in liquid level to a pressure-loading unit for later control.

As discussed above, there are known high-throughput purification schemes using an apparatus equipped with a plurality of solid-phase extraction cartridges, as in Patent Documents 1, 2. Also known is an apparatus that as described in Patent Document 3, includes the mechanism that opens a pressure release valve upon completion of sample discharging from an extraction cartridge in order to prevent the contamination of surroundings due to the splashing of a mist of liquid effluent. Additionally known is an automatic analyzer that as described in Patent Document 4, conducts laboratory tests while detecting that reaction reagents are being appropriately added or diluted. That is to say, in these related techniques, problems of complexity of the apparatus configuration and increases in costs arise since increasing the number of pressure-loading units for improved throughput absolutely involves increasing the number of liquid-level detection mechanisms as well. In addition, there exists no system or mechanism that conducts feedback control of a pressure application rate of a pressure-loading unit in line with a preset number of fractions (extraction rates and volumes) by detecting liquid levels in a solid-phase extraction cartridge and in a receiving tray which is to receive the constituents extracted. Further, this invention aims to provide a pretreatment device in which liquid levels are detected in all steps of applying a pressure, which is enabled by sharing one liquid-level detection mechanism for all pressure-loading units present on a continuous-tracked turntable that is capable of holding a plurality of solid-phase extraction cartridges. This yields an effect in that the apparatus, compared with the conventional ones that automatically conduct solid-phase extraction, can achieve cost reduction, carry-over reduction, and random and high-throughput solid-phase extraction in a simplified configuration. Additionally, each solid-phase extraction cartridge, which operates in an offline sequence, can be used with progressive eluting steps using a plurality of eluting solvents, that enable separation power which is high relative to that of the existing apparatuses. Also disposed are a liquid-level sensor for detecting the liquid levels in the solid-phase extraction cartridge and in the receiving tray which is to receive the constituents extracted, and a mechanism that conducts feedback control of the pressure application rates of each pressure-loading unit with respect to detection data obtained using the liquid-level sensors.

An object of the present invention is to provide a clinical laboratory apparatus that processes multiple analytical test items concurrently at the same time for multiple kinds of samples and flexibly responds to diverse and irregular requests for clinical laboratory tests. In addition, the apparatus includes a pretreating apparatus having a high separation capability and providing high data reproducibility and reliability. Another object of the present invention is to provide a mass spectrometer that in combination with the pretreating apparatus, can execute fully automatic processing from pretreatment to detection.

### Means for Solving the Problems

The pretreating apparatus includes: a cartridge for holding an extraction agent for solid-phase extraction; a solid-phase extraction cartridge-retaining unit with a capacity to retain the cartridge in plurality; at least one pressure-loading unit for applying a pressure load to any cartridge mounted on the solid-phase extraction cartridge-retaining unit; a pressure hold mechanism for retaining the pressure applied to the cartridge at the pressure-loading unit; a receiving tray mechanism for receiving a sample extracted from the cartridge; a liquid-level sensor for detecting liquid levels in the receiving tray as well as in the cartridge; a pressure sensor for detecting a pressure of the pressure-loading unit; a pressure release valve for releasing the pressure; and a control device with an algorithm incorporated therein to execute feedback control in accordance with output values of each sensor so that the pressure release valve will be released when at least one of the liquid-level positions detected by the liquid-level sensor reaches a liquid-level position preset for a particular extent of the pressurization at the pressure-loading unit. In addition to the pretreating apparatus, the analyzing apparatus includes a mass spectrometer with a sample ionizer and a mass analyzer.

The solid-phase extraction agent in the above apparatus configuration can be of any type, as long as the extraction agent lets the liquid under analysis pass therethrough and selectively separates analyte constituents. In addition, the cartridge can take any structure, as long as the cartridge holds the extraction agent during the pretreatment: such as, for example, a cylindrical one internally possessing a solid-phase extraction agent. The pressure hold mechanism can be of any type, only if it functions to maintain an internal pressure, as with a one-way valve. The liquid-level sensor can be of any kind, only if it senses changes in liquid level. The liquid-level sensor can be of, for example, either a non-contact type such as a CCD camera, or a contact type that detects a refractive index. The pressure sensor can be of any kind, only if it can detect changes in pressure.

### Effects of the Invention

As described above, the present invention with these and other features and characteristics provides an apparatus that changes stepwise a concentration of eluting-solvent constituents introduced into solid-phase extraction cartridges and sequentially recovers constituents of an eluate using a plurality of receiving trays. Thus, the apparatus decreases in carry-over and improves in throughput, compared with the conventional apparatuses that automatically conduct solid-phase extraction. A liquid-level sensor for detecting liquid levels in each solid-phase extraction cartridge or in each receiving tray or in both thereof is also disposed, and the detection of liquid levels in all steps of applying a pressure is accomplished by sharing one liquid-level detection mechanism for all pressure-loading units present on a continuous-tracked turntable. This yields the advantageous effect that the apparatus, compared with the conventional ones that automatically conduct solid-phase extraction, can reduce carry-over and achieve random and high-throughput solid-phase extraction in a simplified configuration. In addition, the apparatus includes a mechanism that upon the preset liquid-level position being reached, deactivates a loading operation of each pressure-loading unit or releases an internal pressure of the solid-phase extraction cartridge. Accordingly, even for samples whose physical properties, for example, viscosity and other factors, vary from patient to patient, reproducibility can be obtained in the step of passing the sample through an internal solid-phase extraction agent of the solid-phase extraction cartridge, and highly reproducible, highly reliable data can be acquired in addition to excellent power to separate the analysis object into constituents and analyte drugs. Similarly, even if the kind (shape, density, or separation mode) of extraction agent in the solid-phase extraction cartridge differs, reproducibility can be obtained in the step of passing solutions through the internal solid-phase extraction agent of the solid-phase extraction cartridge, and highly reproducible, highly reliable data can be acquired in addition to the excellent power to separate the analysis object into constituents and analyte drugs.

### BRIEF DESCRIPTION OF THE DRAWINGS

FIG. 1 is a plan view of an automatic analyzer in an embodiment of the present invention;

FIG. 2 is a front view of turntables 101 and 105, and neighboring sections thereof, in the automatic analyzer according to the embodiment of the present invention;

FIG. 3 is a schematic diagram that shows shapes of, and a relationship in position between, each of cartridge-holding containers 103 arranged on the turntable 101 of the automatic analyzer according to the embodiment of the present invention, and each of receiving trays 106 arranged on the turntable 105, wherein FIG. 3-1 shows one structural form, FIG. 3-2 shows another structural form and FIG. 3-3 shows yet another structural form;

FIG. 4 is a schematic operational flowchart of solid-phase extraction by the automatic analyzer in the embodiment of the present invention;

FIG. 5 is a schematic showing an example of applying an ultrasonic sensor as a liquid-level sensor in the embodiment of the present invention;

FIG. 6 is a schematic showing an example of applying an optical sensor as the liquid-level sensor in the embodiment of the present invention;

FIG. 7 is a front view showing a positive-pressure loading type of pressure-loading unit;

FIG. 8 is a diagram representing a relationship between an elution time and an organic solvent concentration, obtained by using an reversed-phase column as an extraction agent packed in a solid-phase extraction cartridge, section (A) of FIG. 8 being a stepwise gradient elution characteristics curve and section (B) being a linear gradient elution characteristics curve;

FIG. 9 is a schematic of the solid-phase extraction cartridge; and

FIG. 10 shows an embodiment of a pretreating apparatus equipped with a plurality of pressure-loading units.

### MODES FOR CARRYING OUT THE INVENTION

Hereunder, embodiments of the present invention will be described with reference to the accompanying drawings.

### First Embodiment

An embodiment of an automatic analyzer according to the present invention is described in detail below referring to the accompanying drawings. The present embodiment is an example of a mode for carrying out the invention and does not limit the invention.

Methods of analyzing biological samples are divided into two major types. One type is colorimetric analysis, which uses a multi-wavelength photometer to analyze a change in a color of a reagent formed so as to change its color upon reacting with the analysis object in the sample. The other type is immunoassay methods, which utilize antigen-antibody reactions. In the latter type, a substance that specifically reacts with a constituent to be analyzed is added as a reagent, and then the quantity of substance which has specifically reacted is counted to analyze the constituent of interest. In addition to the two major types of analytical methods, a mass spectrometer has been attempted for use as a detector to assay substances of even minute quantities in recent years, with a view to therapeutic drug monitoring (TDM).

Examples of TDM include pharmacokinetic observation. In administering drugs to patients in a medical treatment situation, it is important, in perspective of ensuring efficacy and safety, to set up an appropriate dosing plan personalized for each patient according to symptoms of the patient dosed. Even the same amount of drugs may develop different therapeutic effects depending on patients. These differences in efficacy, potentially caused by the differences in pharmacokinetics among individuals, can appear as the difference in a blood concentration of the drug. Accordingly, TDM is used as a technique for measuring the blood concentrations of the drug in individual patients and optimizing its patient-specific dosage rates and dosing procedures for the blood concentrations to stay in therapeutic concentration ranges.

Measurement of drug concentration for TDM requires sensitivity satisfactory for clinical applications, where the sample blood volume is small, in addition to the promptness and ease of measurement. Thus, immunoassay analysis is widely used. Immunoassays, however, have disadvantages in that the necessity to create antibodies for drugs tends to increase testing costs, in that cross reactions to metabolites and other similar compounds are prone to occur, and in that the immunoassay methods are not applicable, in the first place, for drugs for which no antibodies can be created. For these reasons, in recent years, diagnosis with physical-chemical detecting principle has been attempted using mass spectrometer as a detector.

In using a mass spectrometer as a detector, constituents are introduced into the mass spectrometer by vaporizing (ionizing) the constituents under high-temperature, high-voltage loads in the ionizing unit provided at the front stage of the spectrometer. Since large quantities of constituents ranging over at least several tens of thousands of kinds are present in mixed form in such a biologically derived sample as blood or urine, simultaneously ionizing the very large number of kinds of constituents will cause ion suppression in the form of a hindrance to the ionization, resultantly making accurate detection difficult. Before introducing a sample into a mass spectrometer, therefore, it is essential that the sample be pretreated for concentration and purification.

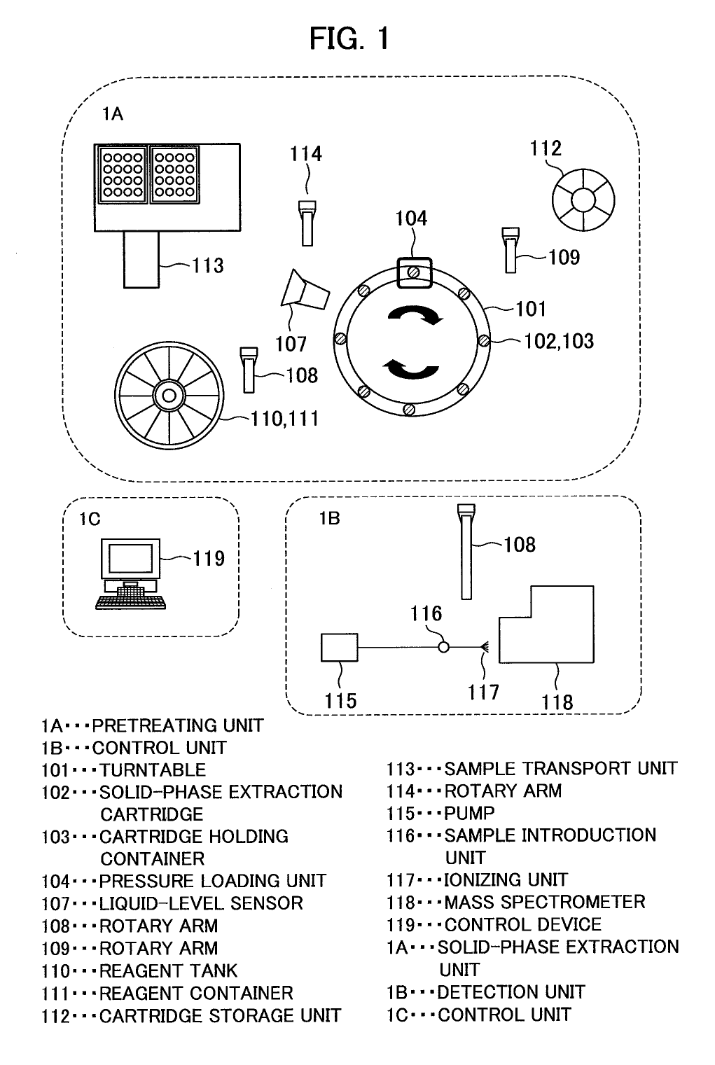

The automatic analyzer according to the present embodiment is composed of a solid-phase extraction unit 1A, a detection unit 1B, and a control unit 1C, as shown in FIG. 1.

The solid-phase extraction unit (1A) includes: a turntable 101 with cartridge-holding containers 103 each placed therein to hold a disposable solid-phase extraction cartridge 102; a cartridge storage unit 112 for containing the solid-phase extraction cartridges 102; a rotary arm 109 for moving each solid-phase extraction cartridge 102 from the cartridge storage unit 112 to the respective cartridge-holding containers 103; a turntable type of reagent tank 110 with reagent containers 111 placed therein; a rotary arm 108 for transferring a reagent from one of the reagent containers 111 to the solid-phase extraction cartridge 102; a pressure-loading unit 104 for applying a pressure load to at least one solid-phase extraction cartridge 102 for later extraction; a turntable 105 with a plurality of receiving trays 106 arranged below the turntable 101 and each constructed to receive a solution extracted from the solid-phase extraction cartridge 102; a rotary arm 108 for transferring the extracted solution from one receiving tray 106 to a sample introduction unit 116; and a liquid-level sensor 107 for detecting how far the extraction is progressing.

The solid-phase extraction cartridge 102 has a pressure release valve that releases a pressure, the valve being constructed to be opened when a liquid level that the liquid-level sensor has detected reaches a preset liquid-level position.

The detection unit 1B includes: a pump 115 that pumps out a solution into an ionizer; the ionizer 117 that will ionize the sample when loaded with a voltage; the sample introduction unit 116, positioned at a stage following the pump 115 and preceding the ionizer 117, for guiding the sample into a flow pathway; and a mass spectrometer 118 that analyzes and tests the ionized sample.

The control unit 1C includes a control device 119 that can automatically control various constituent elements of the apparatus in integrated form.

Testing/analysis by the apparatus, inclusive of solid-phase extraction, is detailed below in order of process steps.

### Step of Adding a Standard Reagent

A standard reagent is first added to a sample that has been carried in by a sample transport unit 113. The rotary arm 108 conducts the addition by suctioning the standard reagent from one reagent container 111 within the reagent tank 110 and adding the reagent to the sample in the sample transport unit 113. The standard reagent usually is either a stable isotope formed by substituting ²H and/or ¹³C for the hydrogen (H) and/or carbon (C), respectively, of the analyte chemical of interest in the sample, or a similar compound of the chemical of interest. The rotary arms 108, 109, 114, each having a distal end provided with a pipette or syringe for suctioning and discharging the reagent, are also equipped with a mechanism that automatically cleans the distal end after reagent suctioning or discharging.

### Removing the Solid-Phase Extraction Cartridges 102

The cartridge storage unit 112 contains the solid-phase extraction cartridges 102 arranged at equal angle intervals from a central point of the turntable 101. The solid-phase extraction cartridges 102 are replaceable, and are sequentially carried into the cartridge-holding containers 103 by the rotary arm 109. The solid-phase extraction cartridges 102 may be carried into the cartridge-holding containers 103 by other transport means such as a belt conveyor.

### Step of Cleaning the Solid-Phase Extraction Cartridges 102

Cleaning of a solid-phase extraction cartridge 102 follows. In the cleaning step, the turntable 101 turns to reach an operating zone of the rotary arm 108, which then suctions a cleaning reagent from one reagent container 111 within the reagent tank 110. The suctioned cleaning reagent is injected into the solid-phase extraction cartridge 102 after that. Next, the turntable 101 turns to reach an operating zone of the pressure-loading unit 104, by which a pressure load is then applied and the cleaning reagent is moved from an upper section of the solid-phase extraction cartridge 102 to a lower section thereof, whereby the cleaning step is conducted. Organic solvent of methanol, acetonitrile, or the like, is usually used as the cleaning solution. The present embodiment employs a 100% methanol solution as the cleaning solution. In addition, the turntable 105 is disposed directly below the turntable 101 of the same shape, and if the constituents extracted need to be captured, the turntables 101 and 105 turn to arrange the receiving trays 106 directly below the cartridge-holding containers 103, and thus enable the capture of the constituents extracted. If the capture of the constituents extracted is not needed, the constituents eluted will be processed as a waste solution. The turntables 101 and 105, both having a mechanism that rotates the turntable both clockwise and semi-clockwise, turn in a direction that each can move to next operating position within a short time.

A plurality of solid-phase extraction cartridges 102 are arranged in the cartridge-holding containers 103 of the turntable 101, and the suctioning and injection of a reagent and the application of a pressure load can be conducted upon respective solid-phase extraction cartridges 102 at the same time.

Referring to the shape of the turntable 101 and a relationship in position between the cartridge-holding containers 103, each cartridge-holding container 103 is positioned at an equal angle interval from the center of the circular turntable 101.

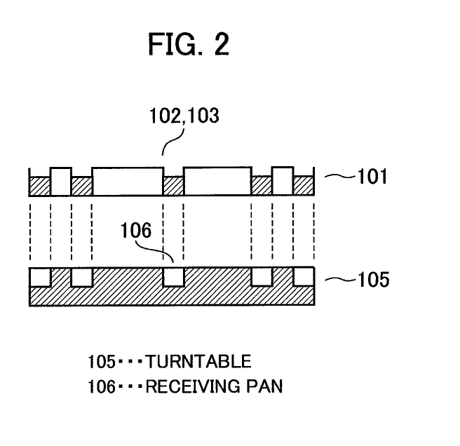

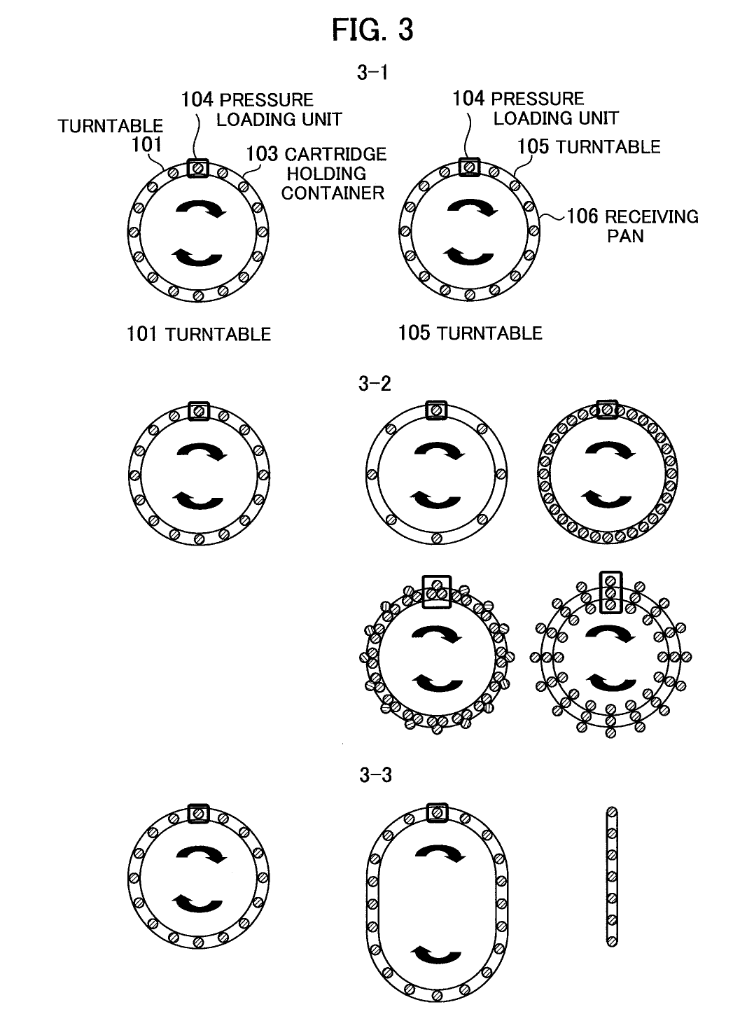

Referring to shape and positional relationship, the cartridge-holding containers 103 in the turntable 101 and the receiving trays 106 in the turntable 105 can take various structural forms. In one structural form, as shown in FIG. 3-1, the turntables 101 and 105 can be the same in shape and the cartridge-holding container 103 and the receiving trays 106 can take a shape in which each is disposed for a layout relationship of one for one, in a perpendicular direction. In another structural form, as shown in FIG. 3-2, whereas the turntables 101 and 105 can be of the same shape, the cartridge-holding containers 103 and the receiving trays 106 can take a shape in which more than one receiving tray 106 is disposed for one cartridge-holding container 103, where the cartridge-holding containers 103 and the receiving trays 106 are not disposed at the rate of one to one correspondence. In yet another structural form, as shown in FIG. 3-3, the turntables 101 and 105 can each have a different shape, for example an elliptical or linear shape, and depending on the shape, can include a plurality of receiving trays 106 for one cartridge-holding container 103.

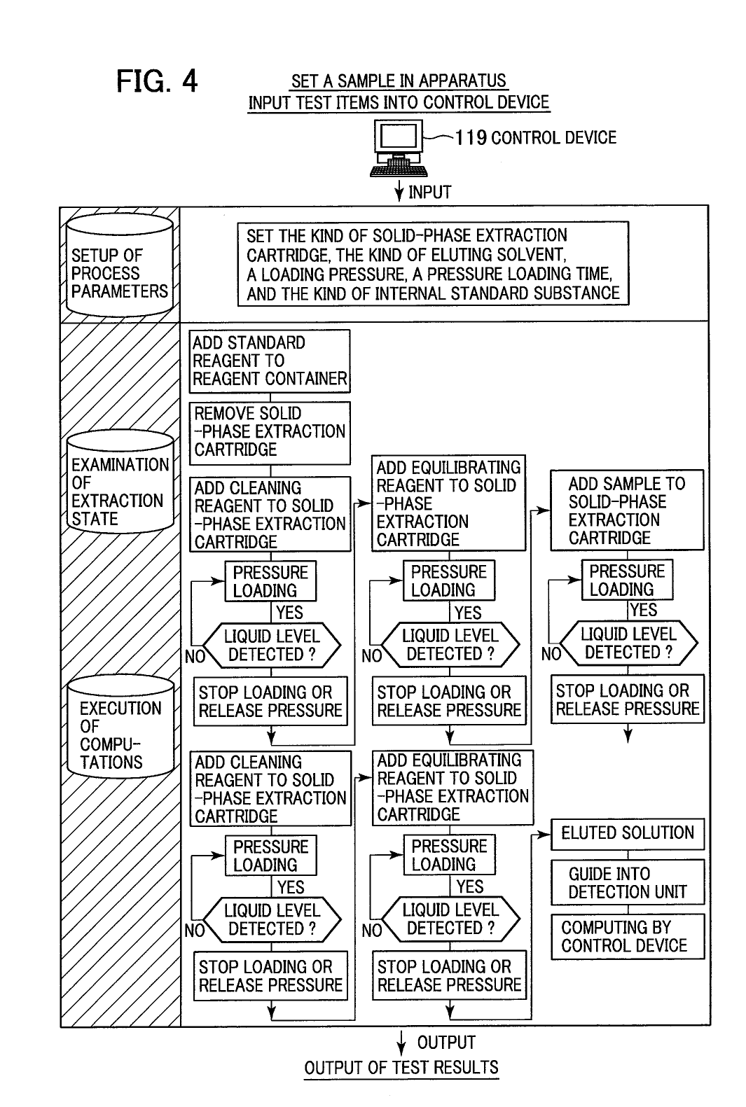

Next, schematic operation of the apparatus in the present embodiment is described below per FIG. 4. A user first introduces a sample into the automatic analyzer for tests/analysis and enters information of analytical test items into the control device 119. The control device 119 including a central processing unit (CPU) and peripheral circuits thereof functions as an arithmetic process device to conduct “Setup of process parameters”, “Examination of extraction state”, and “Execution of computations”, according to predetermined programs for each entered test item, and calculate the data indicating whether the solid-phase extraction is appropriately underway.

The “setup of process parameters” here means determining optimal parameters relating to the kind of solid-phase extraction cartridge, the kind of eluting solvent, a loading pressure, a loading time, and the kind of internal standard substance, for each test item. For example, for carbamazepine, which is a typical antiepileptic drug, the optimal parameters for the solid-phase extraction process are determined as follows; the solid-phase extraction cartridge is one with a reversed-phase type of extraction agent: the eluting solvent is 100% methanol: the loading pressure is 1.0 mmHg: the loading time is 1.0 min: the internal standard is C₁₅D₁₀H₂N₂O (DLM-2806-1.2, manufactured by Cambridge Isotope Laboratories, Inc.). Alternatively to the reversed-phase type, the extraction agent for use in the solid-phase extraction cartridges can be of any other type selected from the group consisting of a normal-phase type, a positive-ion exchange type, a negative-ion exchange type, HILIC (Hydrophilic Interaction Liquid Chromatography) type, chromatofocusing, and GPC (molecular weight fractionation). In addition, if the reversed-phase type is used as the extraction agent of the solid-phase extraction cartridge, solvent elution concentrations are selectable using either of the two methods shown in FIG. 8; that is, the Stepwise Gradient method in which the elution is continued for a fixed time at a constant organic-solvent concentration, and the Linear Gradient method in which an organic-solvent concentration is varied at fixed time intervals. Either method is selected as appropriate, depending on a degree of separation required for each test/analytical operation. The Stepwise Gradient method involves adding elution solvents of different organic-solvent concentrations to the solid-phase extraction cartridge, passing total amounts of each solvent through the cartridge, and capturing with the receiving tray the constituents extracted. The Linear Gradient method, since it involves passing the solvent through the solid-phase extraction cartridge while changing the organic-solvent concentration at fixed time intervals, requires separating/fractionating the to-be-extracted solution by rotating the turntable 101 or 105 or both appropriately according to the liquid level in the solid-phase extraction cartridge or receiving tray, indicated by the liquid-level sensor.

The “examination of extraction state” means the following: conducting the extraction based on the loading pressure and loading time parameters determined during the “Setup of process parameters”, and then detecting whether the liquid level in the solid-phase extraction cartridge or the receiving tray has reached the preset liquid-level position. In conventional methods, such detection has been conducted visually, but the solid-phase extraction using a sample, such as serum, that varies in characteristics from patient to patient, has had problems in that changes in viscosity and loading rate, for example, cannot be sufficiently taken care of, and hence in that the extraction process itself consumes greater deals of labor and time. Because of these problems, during the pretreatment of the serum for the solid-phase extraction, it has been unable to stop the solid-phase extraction at the preset position, and it has been unable to conduct stable extraction, leading to deterioration of analytical/test results. Accordingly, the present embodiment solves the problems by using a liquid-level sensor as a method of detecting a liquid level accurately when serum is moved from an upper section of an extraction agent in a solid-phase extraction cartridge to a lower section of the extraction agent. The liquid-level sensor for detecting the liquid level can be either an ultrasonic sensor, an optical sensor, a CCD camera sensor, or a laser sensor.

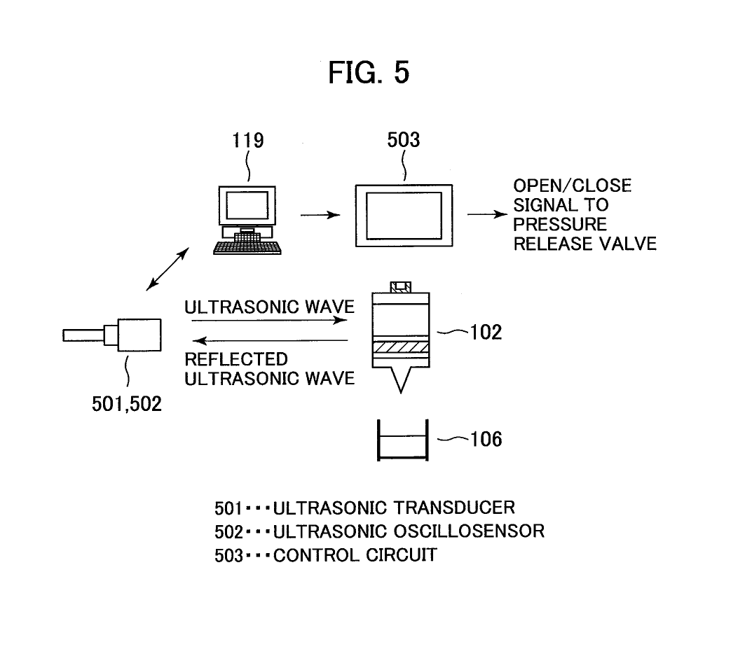

An example of applying an ultrasonic sensor as the liquid-level sensor, is described below per FIG. 5. The ultrasonic sensor includes an ultrasonic transducer that transmits ultrasonic waves either to a solid-phase extraction cartridge and a liquid enclosed therein, or to a receiving tray and a liquid enclosed therein, or to both of the two liquids. The ultrasonic transducer further receives the ultrasonic waves reflected from either of the liquid surfaces. Control device 119 receives input signals at required time intervals from an ultrasonic oscillosensor for sensing a change in the liquid level to be detected, and computes the liquid level change in the ultrasonic oscillosensor from a change in a maximum amplitude value of each received signal. The received signal that the ultrasonic oscillosensor has detected is computed by the control device 119, which then further computes a variation in the received signal and transmits the information through a control circuit, whereby upon a preset value being reached, loading by the pressure-loading unit is stopped or the pressure in the solid-phase extraction cartridge is released therefrom. Thus, the concentrations of the eluting solvent constituents introduced into the solid-phase extraction cartridge will change stepwise and even when the constituents eluted are to be sequentially recovered using a plurality of receiving trays, highly reproducible and highly reliable data is acquirable in addition to excellent power of separating the analysis object into constituents and analyte drugs.

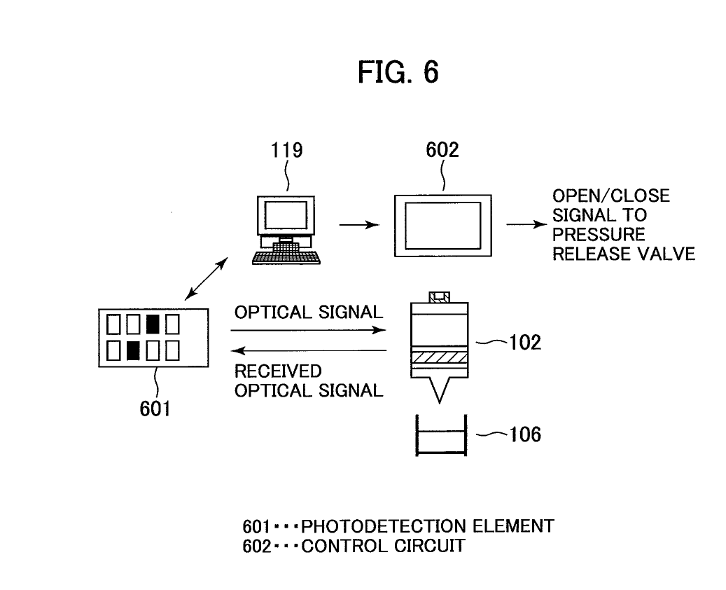

Next, an example of applying an optical sensor as the liquid-level sensor, is described below per FIG. 6. The optical sensor includes optical detection means having one or more arrays of optical detection elements, and a control device 119 constructed integrally with or separately from the optical detection means in order to process the information obtained therefrom. The amount of sample in a solid-phase extraction cartridge or receiving tray, or a total amount of sample in both thereof is detected from an image of the sample in the solid-phase extraction cartridge or receiving tray or both, projected on the optical detection means. The information is next transmitted through a control circuit, whereby upon a preset value being reached, loading by the pressure-loading unit is stopped or the pressure in the solid-phase extraction cartridge is released therefrom. In one method of using the optical sensor, the liquid level is detected by arranging a light-source section and light-receiving section of the optical sensor at a desired liquid-level detection position external to the solid-phase extraction cartridge or the receiving tray, and analyzing the optical characteristics that will change as the liquid level passes the liquid-level detection position. The changes in the optical characteristics during the passage of the liquid level are based on a differential refractive index with respect to the solution. This enables accurate recognition of the sample volume in the solid-phase extraction cartridge or the receiving tray, improvement of the solid-phase extraction process in reproducibility and stability, and supply of high assay accuracy to the user.

The liquid-level position in the solid-phase extraction cartridge or the receiving tray can be detected more accurately by using a CCD-camera-based image sensor in addition to the ultrasonic sensor or the optical sensor. The image-processing sensor ranging between several tens of thousands of pixels to several hundreds of thousands of pixels in resolution can be used to extract a color of the liquid level as the number of pixels. When a color different from that which has been extracted appears and a preset pixel count tolerance is reached, the loading operation of the pressure-loading unit is deactivated or the pressure in the solid-phase extraction cartridge is released therefrom.

The “execution of computations” means creating chronological data on the maximum amplitude values of the received signals detected at fixed time intervals by the various sensors, then after normalizing the chronological data into analytical data and computing standard deviations of the analytical data that correspond to points-of-change of the maximum amplitude values of a predetermined number of received signals, extracting ultrasonic-wave spectral peaks by high-speed Fourier transformation with respect to a waveform of the analytical data, and finally, applying the computed standard deviations and the extracted spectral peaks to determine normality of the solid-phase extraction or abnormality of discharging, from risk-level data calculations. Factors likely to cause the abnormality of discharging include bubbling in the solid-phase extraction cartridge, inclusion of foreign matter, an increase in the viscosity of the liquid, presence of any foreign substances sticking (as solidified substances of the liquid) to the solid-phase extraction cartridge, a failure in the pressure-generating element, and so on. For recovery from the abnormality, the turntable 101 rotates to reach the operating zone of the pressure-loading unit 104, which then applies the pressure load once again. If any form of abnormality is detected even after the recovery operation, a corresponding solid-phase extraction column is replaced and the solid-phase extraction process is repeated. A recovery process executed during initialization associated with a power-on sequence, a settings change, or the like, may be applied as another alternative method of recovery. If the solid-phase extraction is determined to be normal, the process shifts to the next step.

In addition, since the sample tested/analyzed by the automatic analyzer is serum, plasma, blood, or other biologically derived solutions having relatively high viscosity, the sample needs to be moved past from the upper section of the solid-phase extraction cartridge 102 to the lower section thereof by applying a high-pressure load. The result is that a high residual pressure remains after the total amount of solution has been discharged. During the discharge of the total amount of solution, bubbles or a mist may be generated, and if this actually happens, the liquid level in the extraction column is difficult to accurately detect during the generation of the bubbles (mist). The residual pressure may therefore rupture the bubbles and cause a mist or droplets of effluent to splash, or any bubbles grown by the residual pressure are likely to stick to a discharging port or periphery of the extraction column and thus cause contamination to occur and test results to deteriorate. For suppressed occurrence of the mist, therefore, when preset parameters are reached, loading by the pressure-loading unit is stopped or the pressure in the solid-phase extraction cartridge is released therefrom. These take place to stop the flow of the solution before the total amount thereof is discharged.

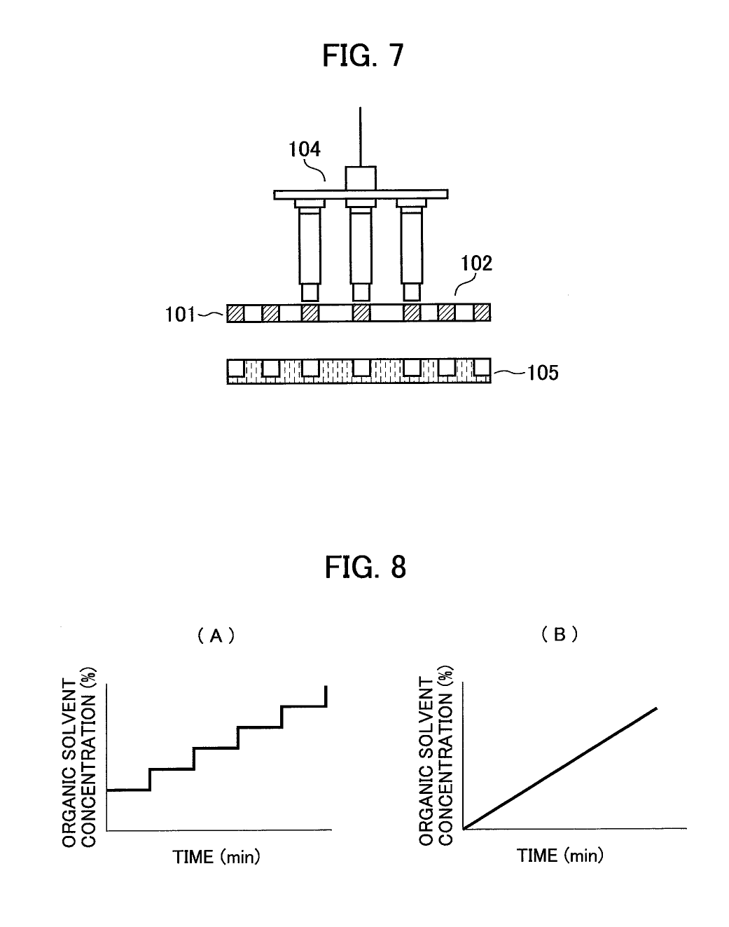

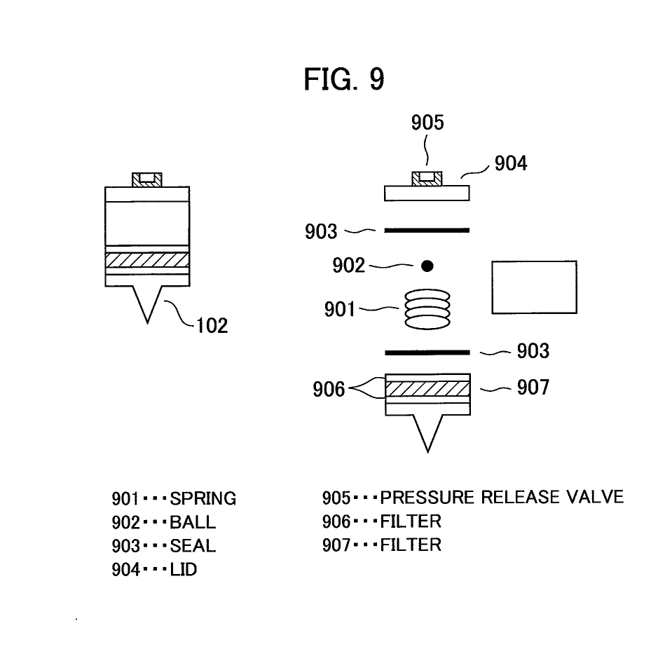

The pressure-loading unit is described below. FIG. 7 is a front view thereof, applying to a case in which the pressure-loading unit is of a positive-pressure loading type. After injection of the solution into the solid-phase extraction cartridge 102, resistance of the extraction agent therein prevents the solution from moving from the upper section of the solid-phase extraction cartridge 102 to the lower section thereof, despite the solution's own weight, such that pressure loading is needed. In the present embodiment, the pressure-loading unit 104 provided above the turntable 101 applies a pressure from above the solid-phase extraction cartridge 102, moving the solution thereunto. The pressure sensor in the solid-phase extraction cartridge to which the sample is added is used to detect the internal pressure of the solid-phase extraction cartridge and determine from detection results to what extent the cartridge is pressure-loaded. A sensor-signal interconnect wire is arranged for transmitting a sensor signal extracted from the pressure sensor, and also a driving-signal interconnect wire for transmitting a driving signal applied to the pressure-generating element such as a pressure element are also arranged in proximity. In order to avoid damage due to the application of the pressure from the pressure-loading unit to the turntable, pressure-loading units may be provided in opposite directions with respect to the center of the turntable for the pressure to be applied equally in a perpendicular direction from an upper section of the turntable. The pressure-loading unit may be of a negative-pressure loading type, in which case, the unit including a vacuum rack, a vacuum pump, and a lid, further has a mechanism that applies a negative pressure to the solid-phase extraction cartridge and the receiving tray during negative-pressure loading. Under the negative pressure, the solution passes through the solid-phase extraction cartridge 102 by moving from the upper section thereof to the lower section. To make the extraction agent in the solid-phase extraction cartridge 102 adsorb the sample or to elute the sample from the extraction agent, the extraction agent needs to be kept in contact with the sample constituents for a certain time. For example, a time of about one minute is required for the sample to pass through a solid-phase extraction cartridge having a capacity of 1 cc. Meanwhile, since a time required for injection of a reagent into the solid-phase extraction cartridge 102 is several seconds, throughput will decrease if the pressure-loading unit 104 exists in one place only. Accordingly, arranging a plurality of pressure-loading units 104 and a plurality of rotary arms 108 and 114 for injecting the reagent and the sample, and providing a mechanism that maintains the internal pressure of the solid-phase extraction cartridge even after pressure loading will enable a plurality of samples to be simultaneously treated and hence, throughput to be improved. While the pressure hold unit for holding the pressure applied to the inside of the solid-phase extraction cartridge in the present embodiment is of such a check valve type as in FIG. 9, the pressure hold unit can be of any type that maintains the internal pressure of the cartridge, as with a one-way valve. A mechanism is provided that uses the above-described liquid-level sensor to deactivate the loading operation of the pressure-loading unit or open the pressure release valve in the solid-phase extraction cartridge upon the preset liquid-level position being reached during an end of the solid-phase extraction. Therefore, even if physical properties, for example, viscosity and/or other factors of the sample vary from patient to patient, reproducibility can be obtained in the step of passing the sample through the solid-phase extraction agent in the solid-phase extraction cartridge, and highly reproducible and highly reliable data can be acquired in addition to the excellent power of separating the analysis object into constituents and analyte drugs. Although the pressure release valve in the present embodiment is an electromagnetic valve capable of being opened and closed using electrical signals, the pressure may be released using physical means, for example by sticking a sharply tipped member, similar to a needle, into the pressure release valve perpendicularly from above.

### Step of Equilibrating the Solid-Phase Extraction Cartridge 102

The solid-phase extraction cartridge 102, once cleaned with an organic solvent, is equilibrated so that the drug constituents contained in the sample will be adsorbable into the solid-phase extraction cartridge 102. In the equilibration step, the reagent tank 110 rotates to reach the operating zone of the rotary arm 108, then the rotary arm 108 suctions/discharges an equilibrating reagent from a reagent container 111, and the rotary arm injects the reagent into the solid-phase extraction cartridge 102. Next, the turntable 101 turns to reach the operating zone of the pressure-loading unit 104, whereby a pressure load is applied for the equilibrating reagent to move from the upper section of the solid-phase extraction cartridge 102 to the lower section thereof, to complete the equilibration step. While a water-containing solution is usually used as the equilibrating reagent, a solution with a 100% water content is employed in the present embodiment.

Step of Adsorption into the Solid-Phase Extraction Cartridge 102

A sample with a standard reagent added is injected into an equilibrated solid-phase extraction cartridge 102 for adsorption of the drug constituents contained in the sample. In the absorption step, the sample transport unit 113 rotates to reach the operating zone of the rotary arm 114, then the rotary arm 114 suctions/discharges one sample from the sample transport unit 113, and the rotary arm injects the sample into the solid-phase extraction cartridge 102. Next, the turntable 101 turns to reach the operating zone of the pressure-loading unit 104, whereby a pressure load is applied for the equilibrating reagent to move from the upper section of the solid-phase extraction cartridge 102 to the lower section thereof, to complete the adsorption step.

### Cleaning Step

Of all constituents that the solid-phase extraction cartridge 102 has adsorbed in the adsorption step, those which have non-specifically become adsorbed are desorbed by execution of the cleaning step, whereby the analyte drug constituents are concentrated. In the cleaning step, the reagent tank 110 rotates to reach the operating zone of the rotary arm 108, then the rotary arm 108 suctions/discharges a cleaning reagent from the reagent container 111, and the rotary arm injects the reagent into the solid-phase extraction cartridge 102. Next, the turntable 101 turns to reach the operating zone of the pressure-loading unit 104, whereby a pressure load is applied for the cleaning reagent to move from the upper section of the solid-phase extraction cartridge 102 to the lower section thereof, to complete the cleaning step. While a solution containing an organic solvent such as methanol or acetonitrile is usually used as the cleaning reagent, a 5% methanol solution is employed in the present embodiment.

### Eluting Step

The eluting step is executed to elute the analyte drugs adsorbed into the solid-phase extraction cartridge 102. In the eluting step, as in the cleaning step, an eluting reagent is injected into the solid-phase extraction cartridge 102 and then a pressure load is applied for the eluting reagent to move from the upper section of the solid-phase extraction cartridge 102 to the lower section thereof, to complete the eluting step. While a solution containing an organic solvent such as methanol or acetonitrile is usually used as the eluting reagent, a 100% methanol solution is employed in the present embodiment.

Introduction into the Detection Unit

The eluted solution is introduced into the detection unit 1B and tested/analyzed. The introduction of the solution into the detection unit 1B is accomplished in accordance with the following sequence: the turntable 105 rotates to reach the operating zone of the rotary arm 108, then the rotary arm 108 suctions/discharges the eluted solution from the receiving tray 106, and the rotary arm introduces the solution into the sample introduction unit 116. The ionizing unit 117 in the present embodiment uses electrospray ionization (ESI) or atmospheric-pressure chemical ionization (APCI). The ionizing unit 117 may use matrix-assisted laser desorption/ionization (MALDI) to conduct ionization with an MALDI plate and a laser light source.

### Second Embodiment

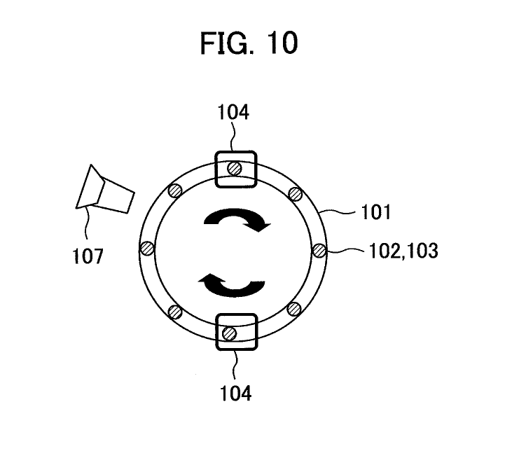

An embodiment equipped with a plurality of pressure-loading units on a continuous-tracked turntable is described in detail below referring to FIG. 10. In the present embodiment, a description is given only of constituent elements thereof that are different from those of the first embodiment. The present embodiment is one example of the invention and does not limit the invention.

The present embodiment includes: a turntable 101 with cartridge-holding containers 103 each formed to hold a disposable solid-phase extraction cartridge 102; a pressure-loading unit 104 for applying a pressure load to at least one solid-phase extraction cartridge 102 for extraction; and a liquid-level sensor 107 provided at a position different from that of the pressure-loading unit, for detecting how far the extraction in at least any one of the solid-phase extraction cartridges 102 is progressing.

Schematic apparatus operation in the second embodiment of the present invention is substantially the same as that of the first embodiment, and description of the schematic operation is therefore omitted.

A liquid-level detection mechanism is provided at a position different from that of a pressure-loading unit. Therefore, liquid levels in all steps of applying a pressure can be detected by sharing one liquid-level detection mechanism for a plurality of pressure-loading units present on a continuous-tracked turntable. Consequently, the apparatus, compared with the conventional ones that automatically conduct solid-phase extraction, can reduce costs and carry-over and achieve random and high-throughput solid-phase extraction in a simplified configuration.

### DESCRIPTION OF REFERENCE NUMBERS

101, 105 Turntable
102 Solid-phase extraction cartridge
103 Cartridge holding container
104 Pressure loading unit
106 Receiving tray
107 Liquid-level sensor
108, 109 Rotary arm,
110 Turntable-type of reagent tank
111 Reagent container
112 Cartridge storage unit
115 Pump
116 Sample introduction unit
117 Ionizing unit
118 Mass spectrometer
119 Control device

1. A method for pretreating biological samples comprising the steps of:
moving each solid-phase extraction cartridge from a cartridge storage unit to respective cartridge-holding containers;
injecting a reagent into each solid-phase extraction cartridge mounted on the respective cartridge-holding containers;
applying pressure to each solid-phase extraction cartridge mounted on the respective cartridge-holding containers;
detecting an amount of pressure applied to each solid-phase extraction cartridge;
detecting liquid-level positions in at least one solid-phase extraction cartridge or a receiving tray mechanism which receives a solution extracted from any of the solid-phase extraction cartridges; and
determining whether or not an abnormality exists based on the detected amount of pressure and detected liquid-level positions in the at least one solid-phase extraction cartridge or the receiving tray mechanism.

2. A method for pretreating biological samples comprising the steps of:
moving each solid-phase extraction cartridge from a cartridge storage unit to respective cartridge-holding containers;
injecting a reagent into each solid-phase extraction cartridge mounted on the respective cartridge-holding containers;
applying pressure to each solid-phase extraction cartridge mounted on the respective cartridge-holding containers;
detecting an amount of pressure applied to each solid-phase extraction cartridge;
detecting liquid-level positions in at least one solid-phase extraction cartridge or a receiving tray mechanism which receives a solution extracted from any of the solid-phase extraction cartridges; and
determining whether or not an abnormality exists based on the detected amount of pressure or detected liquid-level positions in the at least one solid-phase extraction cartridge or the receiving tray mechanism.

3. The method for pretreating biological samples according to claim 1, further comprising:
applying pressure to each solid-phase extraction cartridge mounted on the cartridge-holding container again if it is determined that the abnormality exists.

4. The method for pretreating biological samples according to claim 3, further comprising:
determining whether or not an abnormality of the solid-phase extraction process exists again after applying the pressure again; and
replacing the at least one solid-phase extraction cartridge if the abnormality is determined to exist again.

5. The method for pretreating biological samples according to claim 3, further comprising:
determining whether or not an abnormality of the solid-phase extraction process exists again after applying the pressure again; and
executing initialization associated with a power-on sequence or a settings change if the abnormality is determined to exist again.

6. The method for pretreating biological samples according to claim 2, further comprising:
applying pressure to each solid-phase extraction cartridge mounted on the cartridge-holding container again if it is determined that the abnormality exists.

7. The method of pretreating biological samples according to claim 6, further comprising:
determining whether or not an abnormality of the solid-phase extraction process exists again after applying the pressure again; and
replacing the at least one solid-phase extraction cartridge if the abnormality is determined to exist again.

8. The method for pretreating biological samples according to claim 6, further comprising:
determining whether or not an abnormality of the solid-phase extraction process exists again after applying the pressure again; and
executing initialization associated with a power-on sequence or a settings change if the abnormality is determined to exist again.
